(19) United States
(12) Patent Application Publication
(10) Pub. No.: US 2024/0403672 A1
(43) Pub. Date: Dec. 5, 2024

(54) INTEGRATION OF STRANDED SENSOR DATA FOR FLUID LEAK DETECTION

(71) Applicant: Chevron U.S.A. Inc., San Ramon, CA (US)

(72) Inventors: Larry A. Bowden, JR., Houston, TX (US); Nikolaos Ioannis Salmatanis, Cypress, TX (US); Tyrone Jenkins, Sugar Land, TX (US)

(21) Appl. No.: 18/328,436

(22) Filed: Jun. 2, 2023

(51) Int. Cl. G06N 7/01; G01M 3/04

(52) U.S. Cl. CPC G06N 7/01; G01M 3/04

(57) ABSTRACT

Fluid leak observations made by different types of sensors are collected by an edge device. The edge device generates a graph model to represent the fluid leak observations made by different types of sensors. The graph model is provided by the edge device to a remote device for fluid leak detection at the fluid facility.

### FIELD

The present disclosure relates generally to the field of integrating stranded fluid leak sensor data using a graph model.

### BACKGROUND

Leaks at fluid facilities may cause equipment failure and loss of fluid. Leak detection at fluid facilities may require combination of fluid leak observations made by different types of sensors. Communicating and reconciling fluid leak observations made by different types of sensors may be difficult and costly.

### SUMMARY

This disclosure relates to integrating stranded fluid leak sensor data. Multiple sensors of different types may be configured to make fluid leak observations for a fluid facility. The multiple sensors of different types may include a first sensor of a first type and a second sensor of a second type different from the first type. The first sensor may be configured to make a first fluid leak observation for the fluid facility and the second sensor may be configured to make a second fluid leak observation for the fluid facility. An edge device may be connected to multiple sensors of different types. The fluid leak observations for the fluid facility made by the multiple sensors of different types may be obtained by the edge device. A graph model to represent the fluid leak observations for the fluid facility made by the multiple sensors of different types may be generated by the edge device. The graph model may include multiple fluid leak observation sub-nodes to represent the fluid leak observations. The multiple fluid leak observation sub-nodes may be connected to an edge node representing the edge device. The graph model may be provided by the edge device to a remote device for fluid leak detection at the fluid facility.

A system for integrating stranded fluid leak sensor data may include one or more electronic storage, multiple sensors, one or more edge devices, one or more processors, and/or other components. The electronic storage may store information relating to a fluid facility, information relating to one or more edge devices, information relating to sensors, information relating to fluid leak observations, information relating to a graph model, information relating to fluid leak detection, and/or other information.

Multiple sensors of different types may be configured to make fluid leak observations for a fluid facility. The multiple sensors of different types may include a first sensor of a first type, a second sensor of a second type different from the first type, and/or other sensors. The first sensor may be configured to make a first fluid leak observation for the fluid facility. The second sensor may be configured to make a second fluid leak observation for the fluid facility.

In some implementations, the multiple sensors of different types may include one or more infrared image sensors, one or more sound sensors, one or more emission sensors, one or more polymer absorption sensors, and/or other types of sensors.

In some implementations, the fluid leak observations for the fluid facility made by the multiple sensors of different types may include a first fluid leak probability level detected at a location by the first sensor of the first type, a second fluid leak probability level detected at the location by the second sensor of the second type, and/or other fluid leak probability level(s) detected at the location by other sensor(s).

An edge device may include the processor(s) and/or other components. The edge device may be connected to multiple sensors of different types. In some implementations, one or more of the multiple sensors of different types may be connected to the edge device through one or more other edge devices.

The processor(s) may be configured by machine-readable instructions. Executing the machine-readable instructions may cause the processor(s) to facilitate integrating stranded fluid leak sensor data. The machine-readable instructions may include one or more computer program components. The computer program components may include one or more of an observation component, a graph component, a provision component, and/or other computer program components.

The observation component may be configured to obtain the fluid leak observations for the fluid facility made by the multiple sensors of different types.

The graph component may be configured to generate a graph model. The graph model may be generated to represent the fluid leak observations for the fluid facility made by the multiple sensors of different types. The graph model may include multiple fluid leak observation sub-nodes to represent the fluid leak observations. The multiple fluid leak observation sub-nodes may be connected to an edge node representing the edge device.

The provision component may be configured to provide the graph model to a remote device for fluid leak detection at the fluid facility. In some implementations, the graph model may be provided to the remote device using MQTT protocol and/or other communication protocol(s).

In some implementations, the fluid leak detection at the fluid facility may include reconciliation of different fluid leak probability levels detected by different ones of the multiple sensors of different types using a Bayesian model. The Bayesian model may determine likelihoods of multiple fluid leak probability levels at the location based on separate fluid leak probability levels detected at the location by the multiple sensors and/or other information.

In some implementations, whether the location includes a fluid leak may be determined based on highest of the likelihoods of multiple fluid leak probability levels at the location and/or other information. In some implementations, the edge node representing the edge device may include the edge node including information on determination of whether the location includes the fluid leak based on the highest of the likelihoods of multiple fluid leak probability levels at the location and/or other information.

In some implementations, the fluid leak detection may be performed by the edge device and one or more results of the fluid leak detection may be communicated by the edge device to the remote device.

In some implementations, the fluid leak detection may be performed by the remote device and one or more results of the fluid leak detection may be communicated by the remote device to the edge device.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for integrating stranded fluid leak sensor data.

FIG. 2 illustrates an example method for integrating stranded fluid leak sensor data.

FIG. 3 illustrates an example diagram of aggregation and distribution of sensor observations for fluid leak detection.

FIG. 4A illustrates an example graph model for an edge device.

FIG. 4B illustrates an example graph model for two edge devices.

FIG. 5 illustrates an example Bayesian model diagram.

FIG. 6 illustrates an example probability table for a Bayesian model.

### DETAILED DESCRIPTION

The present disclosure relates to integrating stranded fluid leak sensor data. Fluid leak observations made by different types of sensors are collected by an edge device. The edge device generates a graph model to represent the fluid leak observations made by different types of sensors. The graph model is provided by the edge device to a remote device for fluid leak detection at the fluid facility.

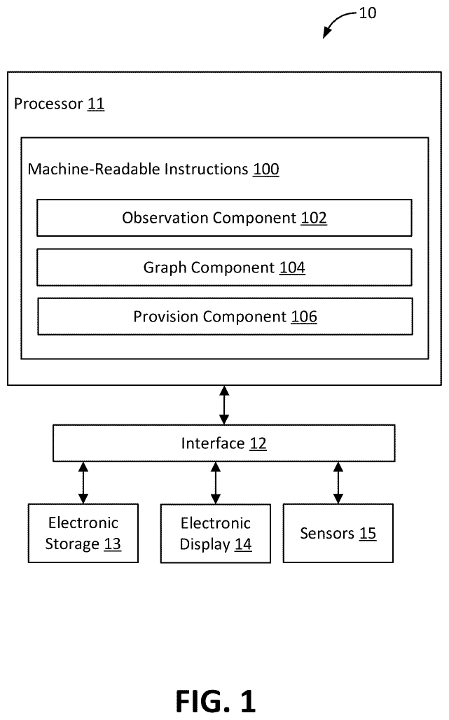

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, sensors 15, one or more edge devices, and/or other components. One or more components of the system 10 may be part of an edge device. For example, the processor 11 may be part of an edge device.

The sensors 15 may include multiple sensors of different types. Multiple sensors of different types may be configured to make fluid leak observations for a fluid facility. The multiple sensors of different types may include a first sensor of a first type, a second sensor of a second type different from the first type, and/or other sensors of other types. The first sensor may be configured to make a first fluid leak observation for the fluid facility and the second sensor may be configured to make a second fluid leak observation for the fluid facility.

An edge device including the processor 11 may be connected to the sensors 15 (multiple sensors of different types). The fluid leak observations for the fluid facility made by the multiple sensors of different types may be obtained by the processor 11. A graph model to represent the fluid leak observations for the fluid facility made by the multiple sensors of different types may be generated by the processor 11. The graph model may include multiple fluid leak observation sub-nodes to represent the fluid leak observations. The multiple fluid leak observation sub-nodes may be connected to an edge node representing the edge device. The graph model may be provided by the processor 11 to a remote device for fluid leak detection at the fluid facility.

The electronic storage 13 may include one electronic storage media that electronically stores information. The electronic storage 13 may store software algorithms, information determined by the processor 11, information received remotely, and/or other information that enables the system 10 to function properly. For example, the electronic storage 13 may store information relating to a fluid facility, information relating to one or more edge devices, information relating to sensors, information relating to fluid leak observations, information relating to one or more graph models, information relating to fluid leak detection, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a fluid facility, information relating to one or more edge devices, information relating to sensors, information relating to fluid leak observations, information relating to one or more graph model, information relating to fluid leak detection, and/or other information.

A fluid facility may refer to a facility (e.g., place, equipment, etc.) that generates, processes, stores, transports, and/or otherwise operates on fluid. Fluid may refer to substance that has no fixed shape. Fluid may refer to substance that yields easily to external pressure. Fluid may be composed of a single type of substance or multiple types of substance. Fluid may exist in one or more forms, such as liquid and/or gas. Examples of fluid include hydrocarbon gas, hydrocarbon liquid, water, wastewater, and chemicals. Examples of liquid include crude gasoline, raw pyrolysis gasoline, diesel fuel, jet fuel, produced water, liquid propane, tailings, ethylene, propylene, liquid carbon dioxide, natural gas liquids, and gas condensate. Examples of gas include natural gas, hydrogen, hydrogen sulfide, nitrogen, carbon dioxide, and methane. Other types of fluid are contemplated.

A fluid leak may refer to fluid escaping from a fluid facility. A fluid leak may include a gas leak and/or a liquid leak. A fluid leak may refer to fluid escaping from equipment at a fluid facility. For example, a fluid leak may refer to fluid escaping from pipes, containers, and/or other equipment that generates, processes, stores, transports, and/or otherwise operates on the fluid. Fluid leaks at fluid facilities may cause damage to the fluid facilities, cause damage to surrounding areas, disrupt fluid facility operations (e.g., cause production disruptions), pose safety hazards, and/or cause other problems. It is critical to detect fluid leaks at fluid facilities.

Observations made by sensors of different types at a fluid facility may enable detection of fluid leaks at the fluid facility. However, sensors may be located at different places in the fluid facility. Sensors may be located at remote and/or inaccessible places in the fluid facility. Sensors may be connected to different devices at the fluid facility. Sensors may not be connected into a network or communicate using the same/compatible communication protocol. Thus, accessing and/or sharing sensor data may be difficult, costly, and/or time consuming. Such data may be referred to as stranded data.

Present disclosure provides a tool to enable accessing and/or sharing of stranded sensor data through one or more edge devices. Observations made by sensors of different types may be collected by an edge device, and the observations may be stored in a graph model for sharing. Fluid detection may be performed by the edge device and/or a remote device using the observations stored in the graph model. Observations made by different types of sensors provide separate fluid leak detections at the fluid facility, and different fluid leak detections from different types of sensors are reconciled using a Bayesian model. Reconciliation of the fluid leak detections from different types of sensors may result in more accurate detection of fluid leaks than relying on separate fluid leak detections from different types of sensors.

Fluid leak detections reconciled using the Bayesian model may be used to facilitate one or more operations at the facility. For example, the result of the fluid leak detection reconciliation may be presented to one or more persons at the fluid facility to facilitate operations at the fluid facility (e.g., stop/change operations to stop/change generation, processing, storage, and/or transportation of fluid; stop fluid leak; fix fluid leak). One or more operations at the facility may be automated based on the result of the fluid leak detection reconciliation. One or more alarms may be generated responsive to the result of the fluid leak detection reconciliation.

The tool of the present disclosure enables stranded sensor data to be accessed and utilized remotely from the sensors. The tool helps to reduce costs and improve the efficiency of data-driven processes and operations related to fluid leak detection. The tool is flexible and may be customized to meet the specific needs of different applications and/or users.

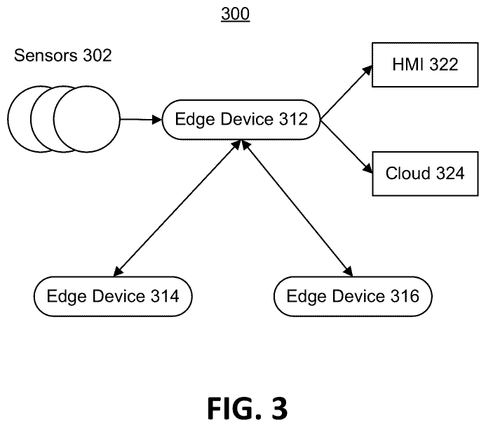

FIG. 3 illustrates an example diagram 300 of aggregation and distribution of sensor observations for fluid leak detection. Conditions at a fluid facility may be observed by multiple sensors 302 of different types (e.g., image sensor, infrared image sensor, sound sensor, point sensor, gas sensor, liquid sensor). Conditions observed by the sensors and/or results of analysis performed on the conditions observed by the sensors may be referred to as fluid leak observations. Fluid leak observations made by the multiple sensors 302 may include and/or be used to determine probability of a fluid leak at the fluid facility (e.g., probability percentage of the fluid leak, low probability of the fluid leak, medium probability of the fluid leak, high probability of the fluid leak). The fluid leak observations made by the multiple sensors 302 may be aggregated at an edge device 312. The edge device 312 may be local to some or all of the multiple sensors 302. The edge device 312 may be connected to other edge devices, such as an edge device 314 and an edge device 316, which may individually be connected to one or more sensors. The edge device 312 may collect fluid leak observations made by sensors connected to other edge devices 314, 316.

An edge device may include a computing device, such as an industrial gateway or a programmable automation controller. An edge device may collect stranded data (e.g., fluid leak observations) from sensors and make the collected data available for use by a remote device. For example, the edge device 312 may be configured to collect data from the multiple sensors 302, generate a graph model to represent the collected data, and provide the graph model to a remote device for fluid leak detection at the facility. A remote device may refer to a remote computing device. A remote device may refer to a computing device located remotely from the edge device 312 or the fluid facility. For example, the edge device 312 may provide the graph model for use through a human-machine interface 322, at the cloud 324, and/or other computing devices. The edge device 312 may be configured to perform various tasks, such as filtering or aggregating the data, as well as to execute user-defined functions or algorithms. The processed data may be accessed by authorized users or applications (e.g., via the central server or cloud platform).

The edge device 312 may be configured to communicate with other devices (e.g., sensors, edge devices, remote devices) using one or more communication protocols. For example, the edge device 312 may communicate with the multiple sensors 302 using ModBus, BACnet, CANbus, IEC 60870, TCP/IP, streaming, and/or other communication protocols. The edge device 312 may communicate with other devices using the same or different communication protocols. For example, the edge device 312 may communicate with other edge devices 314, 316 using MQTT (Message Queuing Telemetry Transport), a lightweight messaging protocol that is well-suited for use in IoT applications. The edge device 312 may communicate with HMI 322 using RESTful API, graphQL, and/or other communication protocols. The edge device 312 may communicate with the cloud 324 using MQTT, FTP, streaming, and/or other communication protocols. Usage of other communication protocols/other combinations of communication protocols is contemplated.

The edge device 312 may make fluid leak observations made by the sensors 302 available to other computing devices in the form of a graph model. The graph model may have a predefined node structure based on the sensor 302 deployed at the fluid facility. The edge device 312 may obtain the fluid leak observations made by the sensors 302, parse out the fluid leak observations, and assign the relevant information to the nodes in the graph model. The graph model may be made available to other computing devices. For example, one or more computing devices may subscribe to a node and receive updates when changes are made to the node. One or more computing devices may query the data contained within the graph model using graphQL API. Other usage of the graph model is contemplated.

Such aggregation and distribution of sensor observations by the edge device 312 enables sensor observations to be used by any computing device, including the edge device 312. Such aggregation and distribution of sensor observations by the edge device 312 enables sensor observations to be shared using one or more communication protocols. Such aggregation and distribution of sensor observations by the edge device 312 reduces the amount of information that needs to be transmitted for fluid leak detection. For example, rather than transmitting all information collected from the sensors 302, the edge device 312 may transmit information associated with/included within particular nodes of the graph model.

Referring back to FIG. 1, the sensors 15 may include multiple sensors of different types. The multiple sensors of different types may include a first sensor of a first type, a second sensor of a second type different from the first type, and/or other sensors. A fluid facility may include the sensors 15 of different types to observe conditions at a location within the fluid facility. Different types of sensors may be used to observe conditions at the location to detect fluid leaks at the location. Example types of sensors deployed at the fluid facility may include one or more infrared image sensors, one or more sound sensors, one or more emission sensors, one or more polymer absorption sensors, and/or other types of sensors.

The sensors 15 of different types may include one or multiple sensors of the same type. For example, conditions at a location within a fluid facility may be observed by one or more infrared image sensors, one or more sound sensors, one or more emission sensors, one or more polymer absorption sensors, and/or other sensors to detect fluid leak probability levels at the location. Multiple infrared image sensors of the same type or different types may be deployed at the location. Other types of sensors may be deployed at the fluid facility.

One or more types of sensors may be deployed at the fluid facility to confirm or invalidate observations made by the sensors of other types that detect fluid leak probability levels. For example, point sensor (e.g., hydrocarbon isotope point sensor, polymer absorption sensor), gas sensor, liquid sensor, methane sensor, hydrocarbon sensor, fiber optic sensor, vibration sensor, pressure sensor, temperature sensor, weather sensor, flow sensor, and/or other sensors may be deployed to confirm or invalidate observations made by other sensors. For instance, point sensor and/or gas sensor may be deployed to confirm or invalidate observations made by infrared image sensor(s) and/or sound sensor(s). Other combinations of sensors are contemplated.

The sensors 15 of different types may be configured to make fluid leak observations for a fluid facility. For example, the first sensor may be configured to make a first fluid leak observation for the fluid facility. The second sensor may be configured to make a second fluid leak observation for the fluid facility. Other sensor(s) may be configured to make other fluid leak observation(s) for the fluid facility. A fluid leak observation may refer to an observation relating to a fluid leak (actual or potential fluid leak) at the fluid facility. A fluid leak observation may include generation of sensor information (e.g., measuring sensor data) for use in detecting a fluid leak at the fluid facility. For example, fluid leak observations made by the sensors 15 may include and/or be used to determine probability of a fluid leak at the fluid facility (e.g., probability percentage of the fluid leak, low probability of the fluid leak, medium probability of the fluid leak, high probability of the fluid leak). For example, the fluid leak observations for the fluid facility made by the sensors 15 may include a first fluid leak probability level detected at a location by the first sensor of the first type, a second fluid leak probability level detected at the location by the second sensor of the second type, and/or other fluid leak probability level(s) detected at the location by other sensor(s).

An edge device may refer to a computing device that controls data flow at the boundary between two or more networks. An edge device may refer to a computing device that provides an entry point into one or more networks. An edge device may be connected to the sensors 15 (multiple sensors of different types). An edge device may enable transfer of information from fluid leak observations made by the sensors 15 to other computing devices.

A fluid facility may include multiple edge devices. For example, an edge device may be placed in the fluid facility for a group of sensors. For instance, different sensors groups/sensors in different locations may be connected to different edge devices. An edge devices may be connected to other edge device(s). One or more of the sensors 15 of different types may be connected to an edge device through one or more other edge devices. The connection between the edge devices may enable transfer of information from fluid leak observations made by sensor(s) connected to one edge device to another edge device. For example, an edge device for a location in the fluid facility may be connected to a sound sensor, an emission sensor, and a polymer absorption sensor. The edge device may not be connected to an image sensor. Another edge device (e.g., fixed hardware, mobile device) may be connected to an image sensor. The fluid leak observation made by the image sensor may be transmitted from one edge device to the other edge device.

An edge device may include the processor 11 and/or other components. The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate integrating stranded fluid leak sensor data. The machine-readable instructions 100 may include one or more computer program components. The machine-readable instructions 100 may include one or more of an observation component 102, a graph component 104, a provision component 106, and/or other computer program components.

The observation component 102 may be configured to obtain the fluid leak observations for the fluid facility made by the sensors 15. The observation component 102 may be configured to obtain the fluid leak observations for the fluid facility made by the multiple sensors of different types. Obtaining a fluid leak observation may include one or more of accessing, acquiring, analyzing, determining, examining, generating, identifying, loading, locating, measuring, opening, receiving, retrieving, reviewing, selecting, storing, and/or otherwise obtaining the fluid leak observation. The observation component 102 may be configured to obtain the fluid leak observations for the fluid facility from multiple sensors of different types and/or multiple sensors of same type.

The fluid leak observations for the fluid facility made by the sensors 15/the multiple sensors of different types may include separate fluid leak probability levels detected at a location by the sensors 15/the multiple sensors of different types. For example, the fluid leak observations for the fluid facility made by the sensors 15/the multiple sensors of different types may include a first fluid leak probability level detected at a location by the first sensor of the first type, a second fluid leak probability level detected at the location by the second sensor of the second type, and/or other fluid leak probability level(s) detected at the location by other sensor(s).

A fluid leak probability level detected at a location by a sensor may refer to measurement by the sensor of the probability that the location has a fluid leak. A fluid leak probability level may include quantification, classification, persistence, and/or other reflection of the probability measured by the sensor that the location has a fluid leak. For example, a fluid leak probability level may include a percentage value that reflects the probability percentage/confidence score of a fluid leak at the location. As another example, a fluid leak probability level may include different classification levels, such as a first fluid leak probability level, a second fluid leak probability level, and/or other fluid leak probability levels (e.g., a high fluid leak probability level, a medium fluid leak probability level, a low fluid leak probability level, etc.). In some implementations, the percentage value of the fluid leak determined by a sensor may be classified into a particular level (e.g., 5% fluid leak probability being classified as a low fluid leak probability level). Other types of fluid leak probability level are contemplated.

The graph component 104 may be configured to generate a graph model for the fluid facility. The graph model may be generated based on the fluid leak observations for the fluid facility made by the sensors 15/the multiple sensors of different types and/or other information. The graph model may be generated to represent the fluid leak observations for the fluid facility. A graph model may refer to a model that represents fluid leak observations for the fluid facility made by the sensors and an edge device connected to the sensors making the fluid leak observations using nodes. In some implementations, a node representing a fluid leak observations may include the node representing the sensor that made the fluid leak observation. Connections between the sensors and the edge device may be represented by edges between the corresponding nodes. A graph model may include a representation of nodes (data) with edges (relationship, connectivity). Sensor data may be mapped to the nodes representing the combination of sensors and data.

A graph model may include multiple fluid leak observation sub-nodes to represent the fluid leak observations made by the sensors. The multiple fluid leak observation sub-nodes may be connected to an edge node representing the edge device to which the sensors are connected. The structure of the graph model may be defined based on the types of sensors deployed at the fluid facility and the edge device(s) to which the sensors are connected. For example, a graph definition may be set for an edge device to define the structure of the graph model for the edge device based on the sensors/types of sensors connected to the edge device. The structure of the graph model may include the number of nodes, the types of nodes, and/or the connections between the nodes in the graph model.

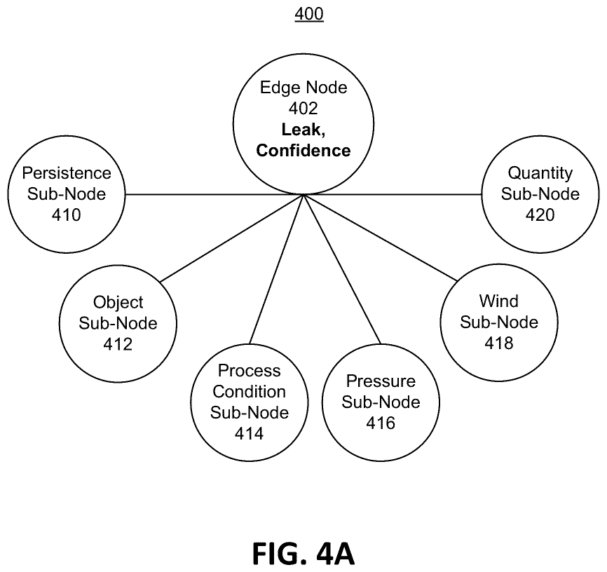

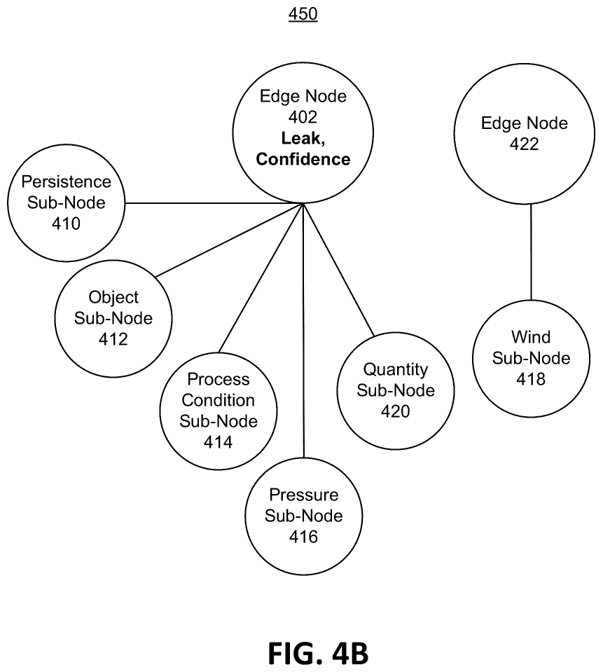

FIG. 4A illustrates an example graph model 400 for an edge device. The graph model 400 may include an edge node 402 to represent an edge device and fluid leak observation sub-nodes 410, 412, 414, 416, 418, 420 to represent different sensors (e.g., object sensor, process condition sensor, pressure sensor, wind sensor) and/or the fluid leak observations made by the different sensors. The graph model 400 may include edges between the edge node 402 and the fluid leak observation sub-nodes 410, 412, 414, 416, 418, 420 represent the connection between the edge device and the different sensors. The types of fluid leak observation sub-nodes in FIG. 4A are provided merely as examples and are not meant to be limiting. Use of other fluid leak observation sub-nodes, such as weather data, wind direction, wind speed, humidity, barometric pressure, temperature, valve position, pump statue, and flowrate, is contemplated.

The fluid leak observation sub-nodes 410, 412, 414, 416, 418, 420 may be updated based on sensor observations made by the sensors. For example, the fluid leak observation sub-nodes 410, 412, 414, 416, 418, 420 may store, include, and/or be associated with sensor data measured by the corresponding sensor and/or the fluid leak probability level detected at the location by the corresponding sensor. For example, the fluid leak observation sub-node 410 may store, include, and/or be associated with sensor data on the persistence of the leak detected at the location (e.g., whether the leak is continuously or intermittently detected, how often leak is detected). The fluid leak observation sub-node 412 may store, include, and/or be associated with sensor data on whether a particular object was or was not detected by an object detection sensor. The fluid leak observation sub-node 414 may store, include, and/or be associated with sensor data on process condition detected by a process condition sensor. The fluid leak observation sub-node 416 may store, include, and/or be associated with sensor data on pressure measured by a pressure sensor. The fluid leak observation sub-node 418 may store, include, and/or be associated with sensor data on wind (e.g., wind speed, wind direction) measured by a wind sensor. The fluid leak observation sub-node 420 may store, include, and/or be associated with sensor data on the quantity of the leak detected at the location (e.g., amount of leak, change in the amount of leak, such as whether the amount of leak is increasing, decreasing, or steady over time). The fluid leak observation sub-nodes 410, 412, 414, 416, 418, 420 may store, include, and/or be associated fluid leak probability level detected at the location by the corresponding sensor.

The fluid leak observation sub-nodes 410, 412, 414, 416, 418, 420 may be updated based on detection of change by the corresponding sensor, based on passage of time, and/or based on other criteria. For example, the sensor data and/or the fluid leak probability level for the fluid leak observation sub-nodes 410, 412, 414, 416, 418, 420 may be updated when the sensor data measured by the corresponding sensor changes (e.g., detection of an object is changed from positive to negative, or vice versa; process condition changes; pressure changes; wind changes) and/or periodically.

In some implementations, one or more of the fluid leak observation sub-nodes 410, 412, 414, 416, 418, 420 may be associated with a probability. For example, the sensor data for a sensor may include probability (e.g., probability of object detection) and this probability may be stored, included, and/or associated with the corresponding fluid leak observation sub-node.

The sensor observations of the fluid leak observation sub-nodes 410, 412, 414, 416, 418, 420 may be used to determine whether or not there is a fluid leak at a location within the fluid facility. Results of fluid leak detection using the fluid leak observation sub-nodes 410, 412, 414, 416, 418, 420 may be stored, included, and/or associated with the edge node 402. For example, the edge node 402 may store, include, and/or be associated with leak/no leak, and the confidence (probability) of the leak/no leak determination.

FIG. 4B illustrates an example graph model 450 for two edge devices. The graph model 450 may include separate graphs for separate edge devices. The graph model 450 may include an edge node 402 to represent one edge device and another edge node 422 to represent another edge device. The edge node 402 may be connected to fluid leak observation sub-nodes 410, 412, 414, 416, 420 which represent sensors and/or fluid leak observations made by sensors connected to the corresponding edge device. The edge node 422 may be connected to fluid leak observation sub-node 418, which represent a sensor and/or fluid leak observation made by a sensor connected to the corresponding edge device.

The sensor observations of the fluid leak observation sub-nodes 410, 412, 414, 416, 418, 420 may be used to determine whether or not there is a fluid leak at a location within the fluid facility. The two graphs may be traversed to obtain sensor observations made by the different sensors for fluid leak detection. Results of fluid leak detection using the fluid leak observation sub-nodes 410, 412, 414, 416, 418, 420 may be stored, included, and/or associated with the edge node 402.

Generation of a graph model that represents the fluid leak observations for the fluid facility may enable the data represented by the graph model to be easily accessed for fluid leak detection. Generation of a graph model that represents the fluid leak observations for the fluid facility may enable stranded sensor data to be accessed by remote devices.

The graph(s) of the graph model may be traversed to obtain data from different nodes, and the data may be used to perform fluid leak detection. For example, a remote device/service may subscribe to one or more nodes to receive updates whenever the information in the node(s) are changed. As another example, a graph query may be used to pull data from specific nodes (e.g., pull objection detection/fluid leak probability from the fluid leak observation sub-nodes 412; pull leak and confidence information from the edge node 402). A graph query may be used to pull data from multiple nodes for use in fluid leak detection. A graph query may be used to pull data from node(s) that meet one or more criteria. A graph query may be used to filter the graph(s), rank the nodes, and/or otherwise manipulate the graph(s). A graph query may be used to determine when certain conditions are detected at the fluid facility. A graph query may combine multiple graphs within a single query. Other uses of the graph model to access information from the graph model are contemplated.

The provision component 106 may be configured to provide the graph model to one or more remote devices for fluid leak detection at the fluid facility. Providing the graph model to a remote device may include giving access to, making available, sending, transmitting, and/or otherwise providing the graph model to the remote device. For example, an edge device may maintain an aggregation of graphs (nodes, edges) created from the available sensor data and relationship between the sensors/sensor data. The aggregation of graphs may be made available to remote device(s) using a graph API specification (e.g., gremlin, graphQL, etc.). The graph model may be provided to the remote device(s) for fluid leak detection at the fluid facility. Provision of the graph model may enable the fluid leak detection to be performed remotely from the edge device. In some implementations, the fluid leak detection may be performed by the edge device, and provision of the graph model may include provision of the result of the fluid leak detection performed by the edge device.

For example, the fluid leak detection may be performed by the edge device using the information stored in the graph model, and one or more results of the fluid leak detection (e.g., whether or not there is a leak at the fluid facility and the probability of the fluid leak determination) may be communicated by the edge device to one or more remote device. As another example, the fluid leak detection may be performed by a remote device and one or more results of the fluid leak detection may be communicated by the remote device to the edge device. The edge device may store the result(s) of the fluid leak detection in the edge node of the graph model.

In some implementations, the graph model may be provided to the remote device(s) using MQTT protocol and/or other communication protocol(s). MQTT protocol may be compatible with IoT applications and use of the MQTT protocol may enable the graph model to be used by IoT applications. Use of other communication protocols is contemplated. For example, MQTT protocol and/or other traditional IoT interfaces may be used to send data from devices/sensors to the edge device. The edge device may create graph(s) representing the sensors, data, and connections between the sensors/devices. The graph(s) may make the sensor data available via a graph API specification (e.g., gremlin, graphQL, etc.). The advantage of this approach is that it generalizes complex relationship/connections between different sensors and makes sensor data from different types of sensors and sensor data connected to different devices generally available via a graph query.

In some implementations, the fluid leak detection at the fluid facility may include reconciliation of different fluid leak probability levels detected by different ones of the sensors 15/the multiple sensors of different types using a Bayesian model. Different fluid leak probability levels detected by different sensors may be reconciled using a Bayesian model. Reconciling different fluid leak probability levels detected by different sensors may include reconciling different fluid leak probability levels detected by sensors of different types (e.g., different fluid leak probability levels detected by an infrared image sensor and a sound sensor at a location) and/or reconciling different fluid leak probability levels detected by multiple sensors of the same type (e.g., different fluid leak probability levels detected by multiple infrared image sensors at a location). Reconciling different fluid leak probability levels detected by different sensors may include settling differences between the different fluid leak probability levels detected by different sensors. Reconciling different fluid leak probability levels detected by different sensors may include combining the different fluid leak probability levels detected by different sensors.

The Bayesian model may refer to a statistical model in which probabilities are used to represent uncertainties. A Bayesian model may make inference based on Bayes theorem. The Bayesian model may reconcile different fluid leak probability levels detected by different sensors by determining likelihoods of the different fluid leak probability levels. The Bayesian model may determine likelihoods of multiple fluid leak probability levels at the location based on separate fluid leak probability levels detected at the location by the sensors 15/the multiple sensors and/or other information, such as analysis of leak growth versus time (e.g., rate of leak growth) and the percent of time the leak is detected in the data (continuous leak versus intermittent leak). For example, a more persistently detected leak and/or a higher amount (concentration/intensity) of leak detected by the sensors may correspond to a higher probability that there is a leak at the location. The Bayesian model may receive as input the separate fluid leak probability levels detected by the sensors and output likelihood of different fluid leak probability levels.

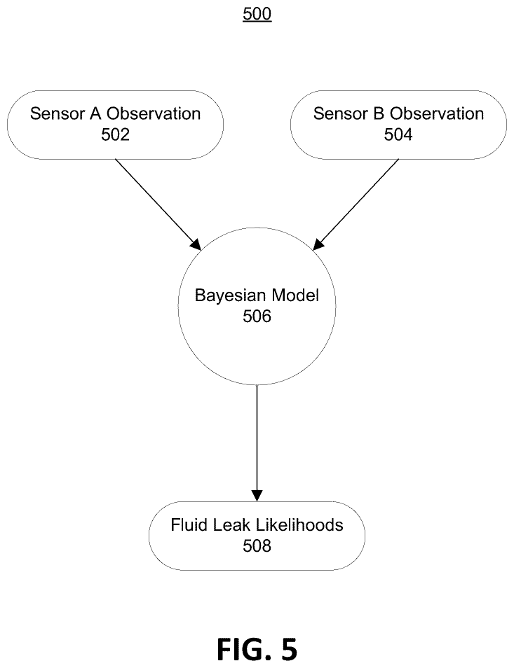

FIG. 5 illustrates an example Bayesian model diagram 500. Inputs to a Bayesian model 506 may include a sensor A observation 502 (e.g., fluid leak probability level detected by a sensor, measurements made by a sensor from which fluid leak probability level is determined) and a sensor B observation 504 (e.g., fluid leak probability level detected by another sensor, measurements made by the other sensor from which fluid leak probability level is determined). The sensor A observation 502 may be different from the sensor B observation 504. The Bayesian model 506 may reconcile the differences between the sensor A observation 502 and the sensor B observation 504, and output fluid leak likelihoods 508 (e.g., likelihoods of different fluid leak probability levels). For example, the inputs into the Bayesian model 506 may include probability percentages of the fluid leak detected by different sensors. The probability percentages may be converted into classification/groups, such as a first fluid leak probability level, a second fluid leak probability level, and/or other fluid leak probability levels (e.g., low fluid leak probability, medium fluid leak probability, and a high fluid leak probability). The Bayesian model 506 may output likelihoods of the different probabilities. That is, the Bayesian model 506 may output probabilities of the different probabilities: probability of the first fluid leak probability being correct; probability of the second fluid leak probability being correct; and probability of other fluid leak probability being correct.

The operation/rules of the Bayesian model may be defined by one or more probability tables. A probability table may define outputs of the Bayesian model based on different combinations of inputs to the Bayesian model. For different combinations of fluid leak probability level values, the probability table may define likelihoods of the different fluid leak probability levels.

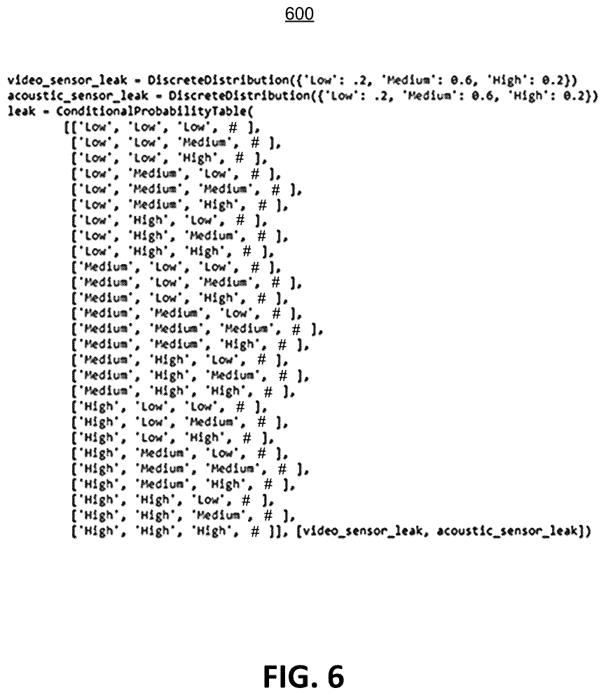

FIG. 6 illustrates an example probability table 600 for a Bayesian model. The probability table 600 may define outputs of a Bayesian model based on different combinations of inputs that include observations made by an image sensor (video sensor) and a sound sensor (acoustic sensor). Inputs into the Bayesian model may include fluid leak probability values (between 0 and 1) detected by the image sensor and the sound sensor. Values between 0 and 0.2 may be classified as low fluid leak probability, values between 0.2 and 0.8 may be classified as medium fluid leak probability, and values between 0.8 and 1 may be classified as high fluid leak probability.

For different combinations of fluid leak probability observed by the two sensors, the probability table 600 may define the likelihood of low fluid leak probability being correct, the likelihood of medium fluid leak probability being correct, and the likelihood of high fluid leak probability being correct. The probability table 600 may define values of the low, medium, and high fluid leak probability being correct for different combinations of fluid leak probability observed by the different sensors. The values assigned to different combinations of fluid leak probability may be determined based on historical fluid leaks (e.g., actual fluid leaks, fluid leak tests). Sensor observations for different fluid leaks may be measured and used to tune the values assigned to different combinations of fluid leak probability. The output of the Bayesian model may include the likelihood of low fluid leak probability, the likelihood of medium fluid leak probability, and the likelihood of high fluid leak probability. Other information relating to the fluid leak may be output.

While FIG. 6 shows the probability table 600 defining the likelihood values for a high fluid leak probability level, a medium fluid leak probability level, a low fluid leak probability level, this is merely as an example and is not meant to be limiting. The Bayesian model may output likelihood for individual types of observations that may be made by a sensor. Other classification/grouping of fluid leak probability observations are contemplated.

In some implementations, the classification/grouping of fluid leak probability observations may be dynamic. In some implementations, the classification/grouping of fluid leak probability observations may be static. In some implementations, the classification/grouping of fluid leak probability observations may be defined/set by a user. In some implementations, the classification/grouping of fluid leak probability observations may be defined/set based on distributions of the fluid leak probability observations. For example, the number of classification/grouping and/or the values that fall within different classification/group may be determined based on desired values and/or corresponding distribution.

For instance, the fluid leak probability observations may be separated into three different groups (e.g., low fluid leak probability level, medium fluid leak probability level, and a high fluid leak probability level). The fluid leak probability observations that fall within the first group (e.g., low fluid leak probability level) may be set so that the first group includes fluid leak probability observations less than 30%. The fluid leak probability observations that fall within the second group (e.g., medium fluid leak probability level) may be set so that the second group includes fluid leak probability observations between 30% and 90%. The fluid leak probability observations that fall within the third group (e.g., high fluid leak probability level) may be set so that the third group includes fluid leak probability observations greater than 90%.

In some implementations, different groups of fluid leak probability observations may be associated with different operations at the fluid facility. For example, if low fluid leak probability level is determined at the fluid facility, the fluid leak may be validated with currently planned operation(s) at the fluid facility. If medium fluid leak probability level is determined at the fluid facility, unplanned validation operation(s) may be scheduled/performed at the fluid facility. If high fluid leak probability level is determined at the fluid facility, operation(s) (e.g., remedial operation(s)) may be scheduled/performed at the fluid facility without the need for additional validation. Other numbers of classification/grouping of fluid leak probability observations, other ranges of fluid leak probability observations within classification/grouping, and other operations at the fluid facility are contemplated.

Other information may be input into the Bayesian model to affect the probability likelihood determination. For example, in addition to observations made by different types of sensors, information about the fluid facility and/or the environment may be used as input to the Bayesian model. For instance, type, design, age, maintenance, inspection, and/or operation of equipment at the fluid facility may affect the probability that a fluid leak will occur at the facility. Information about the type, design, age, maintenance, inspection, and/or operation of equipment at the fluid facility may be obtained and used as input to the Bayesian model to determine the likelihoods of different fluid leak probabilities.

In some implementations, whether the location includes a fluid leak (fluid leak detection) may be determined based on the likelihoods of multiple fluid leak probability levels at the location and/or other information. Whether the location includes a fluid leak may be determined based on values of the likelihoods of the multiple fluid leak probability levels at the location. For example, whether the location includes a fluid leak may be determined based on the highest of the likelihoods of multiple fluid leak probability levels at the location and/or other information. Whether the location includes a fluid leak may be determined based on the highest value of the likelihoods of the multiple fluid leak probability levels at the location.

The highest value among the likelihoods of multiple fluid leak probability levels may be assigned as the fluid leak probability value at the location, this value may be compared to a threshold value to determine whether there is a fluid leak at the location. For example, the Bayesian model may output the likelihood of a high fluid leak probability level as being 4%, the likelihood of a medium fluid leak probability level as being 3.6%, and the likelihood of a low fluid leak probability level as being 0.4%. Based on these numbers, the likelihood of the location including a fluid leak may be set as 4%. The 4% may be compared to a threshold value to determine whether there is a fluid leak at the location. The 4% being larger (or being equal to) than the threshold value may result in determination that there is a fluid leak at the location while the 4% being smaller than the threshold value may result in determination that there is no fluid leak at the location.

As another example, whether the location includes a fluid leak may be determined based on comparison of individual likelihoods of multiple fluid leak probability levels at the location to one or more threshold values. The individual likelihoods of multiple fluid leak probability levels may be compared to the same threshold value (e.g., same threshold value for low, medium, and high fluid leak probability levels) or different threshold values (e.g., different threshold values for low, medium, and high fluid leak probability levels). In some implementations, the location may be determined to include a fluid leak based on at least one of the likelihoods of multiple fluid leak probability levels satisfying the threshold values (e.g., being greater than the threshold values, being same as the threshold values). In some implementations, the location may be determined to include a fluid leak based on multiples of the likelihoods of multiple fluid leak probability levels satisfying the threshold values. In some implementations, the location may be determined to include a fluid leak based on all of the likelihoods of multiple fluid leak probability levels satisfying the threshold values. In some implementations, the location may be determined to include a fluid leak based on the majority of the likelihoods of multiple fluid leak probability levels satisfying the threshold values. Use of other logics to determine a fluid leak based on the likelihoods of the multiple fluid leak probability levels at the location is contemplated.

In some implementations, the edge node representing the edge device may include the edge node including information on determination of whether the location includes the fluid leak based on the likelihoods of multiple fluid leak probability levels at the location and/or other information. For example, the edge node may include information on determination of whether the location includes the fluid leak based on the highest of the likelihoods of multiple fluid leak probability levels at the location and/or other information. For instance, the edge node may store, include, and/or be associated with the highest value of the likelihoods of the multiple fluid leak probability levels at the location. The highest value of the likelihoods of the multiple fluid leak probability levels at the location may be used as the confidence of fluid leak detection result at the location.

In some implementations, the determination of whether the location includes the fluid leak based on the likelihoods of multiple fluid leak probability levels at the location (e.g., based individual, multiple, or the highest of the likelihoods of multiple fluid leak probability levels) may be confirmed or invalidated. Confirmation or invalidation of the fluid leak detection may be performed based on observation made by one or more other sensors different from the multiple sensors that provide observations for the Bayesian model, and/or other information.

Sensors used to confirm/invalidate fluid leak detection may include point sensor (e.g., hydrocarbon isotope point sensor, polymer absorption sensor), gas sensor, liquid sensor, methane sensor, hydrocarbon sensor, fiber optic sensor, vibration sensor, pressure sensor, temperature sensor, weather sensor, flow sensor, and/or other sensors. For example, point sensor and/or gas sensor may be deployed to confirm or invalidate observations made by infrared image sensor(s) and/or sound sensor(s).

For example, vibration of equipment at the facility may cause noise, which may be falsely detected as the sound of a fluid leak. Observations from the vibration sensor(s) at the facility may be used to determine whether the equipment is vibrating at resonant frequency, which may result in generation of audible noise from the vibration. Detecting of equipment vibrating at resonant frequency may be used to invalidate fluid leak detection from sound sensor observations.

As another example, material detection sensors, such as liquid sensor, gas sensor, or point sensor, may be placed in strategic locations at the fluid facility. Costs of these sensors may make it impractical to place these sensors to cover all areas of the fluid facility. Material detection sensors at certain locations (e.g., locations that collect leaked fluid, locations to which leaked fluids are likely to travel) may be used to determine whether the location actually includes the leaked fluid. Fluid leak detection may be confirmed based on the material detection sensors detecting the leaked fluid. Fluid leak detection may be invalidated based on the material detection sensors not detecting the leaked fluid.

As yet another example, operating parameters of the fluid facility may be used to determine whether a fluid leak can exist at the location. For instance, measurement of consistent pressure/flow in the equipment at the location (e.g., no change in pressure/flow, change in pressure/flow below a threshold value) before and after fluid leak detection may indicate that there is no fluid leak at the location and the fluid leak detection may be invalidated. Change in pressure/flow in the equipment at the location before and after fluid leak detection may indicate that there is fluid leak at the location and the fluid leak detection may be confirmed. Additionally, status of equipment at the location may be used to determine whether there can be fluid leak at the location. For example, if the equipment at the location is not pressurized, then fluid leak at the location is not likely to occur and the fluid leak detection may be invalidated. Similarly, if the values at the location are closed to prevent movement of fluid, then fluid leak at the location is not likely to occur and the fluid leak detection may be invalidated.

In some implementations, rather than use observations by the other sensors in a separate confirmation/invalidation step, the observations by these other sensors may be provided as input into the Bayesian model. That is, rather than using these sensor observations after the Bayesian model analysis to confirm or invalidate the fluid leak detection (from the results of the Bayesian model analysis), the sensor observations may be input into the Bayesian model as part of the analysis in determining the likelihoods of multiple fluid leak probability levels, which may then be used to determine whether there is or is not a fluid leak at the location.

One or more operations at the fluid facility may be facilitated based on the fluid leak detection at the fluid facility and/or other information. Facilitating an operation at the fluid facility may include enabling/assisting in preparation, planning, and/or performance of the operation at the fluid facility. Facilitating an operation at the fluid facility based on the fluid leak detection may include providing (e.g., presenting on a display, generating a message) information relating to the fluid leak detection to one or more persons at the fluid facility and/or one or more persons working on operations at the fluid facility. Facilitating an operation at the fluid facility based on the fluid leak detection may include automating one or more operations at the fluid facility (e.g., stop/change operations to stop/change generation, processing, storage, and/or transportation of fluid; stop fluid leak; fix fluid leak) based on information relating to the fluid leak detection. Other facilitations of operations are contemplated.

In some implementations, the facilitation of the operation(s) at the fluid facility based on the fluid leak detection at a location in the fluid facility may include generation of one or more alerts (alarm(s)) based on a determination that the location includes the fluid leak and/or other information. An alert may include an audible alert, a visual alert, a haptic alert, and/or other alert. The alert may include information about the fluid leak, such as the location of the fluid leak, the timing of the fluid leak, the equipment associated with the fluid leak, and/or the type of fluid in the fluid leak.

In some implementations, the facilitation of the operation(s) at the fluid facility based on the fluid leak detection at a location may include quantifying the fluid leak at the location. Quantification of the fluid leak may include determining the rate at which fluid is being leaked, the total amount of the fluid leak, and/or other quantification of the fluid leak. The fluid leak may be quantified based on sensor observations and/or other information. For example, the fluid leak may be quantified based on operating parameters of the equipment at the location, infrared images captured by infrared image sensor(s), sound captured by sound sensor(s), weather conditions reported by weather sensor(s) and/or other information.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, the electronic display 14, and the sensors 15 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, the electronic display 14, and the sensors 15 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

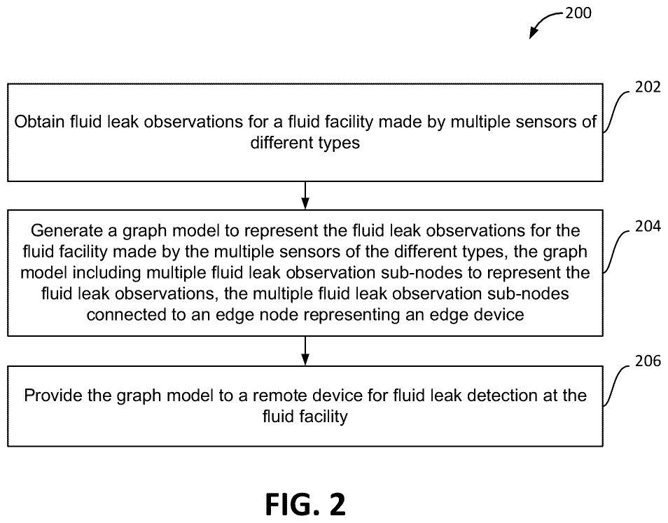

FIG. 2 illustrates method 200 for integrating stranded fluid leak sensor data. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, multiple sensors of different types may be configured to make fluid leak observations for a fluid facility. The multiple sensors of different types may include a first sensor of a first type and a second sensor of a second type different from the first type. The first sensor may be configured to make a first fluid leak observation for the fluid facility and the second sensor may be configured to make a second fluid leak observation for the fluid facility. An edge device may be connected to multiple sensors of different types.

At operation 202, the fluid leak observations for the fluid facility made by the multiple sensors of different types may be obtained. In some implementations, operation 202 may be performed by a processor component the same as or similar to the observation component 102 (Shown in FIG. 1 and described herein).

At operation 204, a graph model to represent the fluid leak observations for the fluid facility made by the multiple sensors of different types may be generated. The graph model may include multiple fluid leak observation sub-nodes to represent the fluid leak observations. The multiple fluid leak observation sub-nodes may be connected to an edge node representing the edge device. In some implementations, operation 204 may be performed by a processor component the same as or similar to the graph component 104 (Shown in FIG. 1 and described herein).

At operation 206, the graph model may be provided to a remote device for fluid leak detection at the fluid facility. In some implementations, operation 206 may be performed by a processor component the same as or similar to the provision component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for integrating stranded fluid leak sensor data, the system comprising:
multiple sensors of different types configured to make fluid leak observations for a fluid facility, the multiple sensors of different types including a first sensor of a first type and a second sensor of a second type different from the first type, the first sensor configured to make a first fluid leak observation for the fluid facility and the second sensor configured to make a second fluid leak observation for the fluid facility; and
a first edge device including one or more physical processors, the first edge device connected to the multiple sensors of different types, the one or more physical processors configured by machine-readable instructions to:
obtain the fluid leak observations for the fluid facility made by the multiple sensors of different types;
generate a graph model to represent the fluid leak observations for the fluid facility made by the multiple sensors of different types, the graph model including multiple fluid leak observation sub-nodes to represent the fluid leak observations, the multiple fluid leak observation sub-nodes connected to a first edge node representing the first edge device; and
provide the graph model to a remote device for fluid leak detection at the fluid facility.

2. The system of claim 1, wherein the multiple sensors of different types include an infrared image sensor, a sound sensor, an emission sensor, and a polymer absorption sensor.

3. The system of claim 1, wherein the fluid leak observations for the fluid facility made by the multiple sensors of different types include a first fluid leak probability level detected at a location by the first sensor of the first type and a second fluid leak probability level detected at the location by the second sensor of the second type.

4. The system of claim 3, wherein the fluid leak detection at the fluid facility includes reconciliation of different fluid leak probability levels detected by different ones of the multiple sensors of different types using a Bayesian model, wherein the Bayesian model determines likelihoods of multiple fluid leak probability levels at the location based on separate fluid leak probability levels detected at the location by the multiple sensors.

5. The system of claim 4, wherein whether the location includes a fluid leak is determined based on highest of the likelihoods of multiple fluid leak probability levels at the location.

6. The system of claim 5, wherein the first edge node representing the first edge device includes the first edge node including information on determination of whether the location includes the fluid leak based on the highest of the likelihoods of multiple fluid leak probability levels at the location.

7. The system of claim 4, wherein the fluid leak detection is performed by the first edge device and a result of the fluid leak detection is communicated by the first edge device to the remote device.

8. The system of claim 4, wherein the fluid leak detection is performed by the remote device and a result of the fluid leak detection is communicated by the remote device to the first edge device.

9. The system of claim 1, wherein the first edge device is connected to the first sensor through a second edge device.

10. The system of claim 1, wherein the graph model is provided to the remote device using MQTT protocol.

11. A method for integrating stranded fluid leak sensor data, the method comprising:
obtaining fluid leak observations for a fluid facility made by multiple sensors of different types, the multiple sensors of different types including a first sensor of a first type and a second sensor of a second type different from the first type, the first sensor configured to make a first fluid leak observation for the fluid facility and the second sensor configured to make a second fluid leak observation for the fluid facility, wherein a first edge device is connected to the multiple sensors of different types;
generating a graph model to represent the fluid leak observations for the fluid facility made by the multiple sensors of different types, the graph model including multiple fluid leak observation sub-nodes to represent the fluid leak observations, the multiple fluid leak observation sub-nodes connected to a first edge node representing the first edge device; and
providing the graph model to a remote device for fluid leak detection at the fluid facility.

12. The method of claim 11, wherein the multiple sensors of different types include an infrared image sensor, a sound sensor, an emission sensor, and a polymer absorption sensor.

13. The method of claim 11, wherein the fluid leak observations for the fluid facility made by the multiple sensors of different types include a first fluid leak probability level detected at a location by the first sensor of the first type and a second fluid leak probability level detected at the location by the second sensor of the second type.

14. The method of claim 13, wherein the fluid leak detection at the fluid facility includes reconciliation of different fluid leak probability levels detected by different ones of the multiple sensors of different types using a Bayesian model, wherein the Bayesian model determines likelihoods of multiple fluid leak probability levels at the location based on separate fluid leak probability levels detected at the location by the multiple sensors.

15. The method of claim 14, wherein whether the location includes a fluid leak is determined based on highest of the likelihoods of multiple fluid leak probability levels at the location.

16. The method of claim 15, wherein the first edge node representing the first edge device includes the first edge node including information on determination of whether the location includes the fluid leak based on the highest of the likelihoods of multiple fluid leak probability levels at the location.

17. The method of claim 14, wherein the fluid leak detection is performed by the first edge device and a result of the fluid leak detection is communicated by the first edge device to the remote device.

18. The method of claim 14, wherein the fluid leak detection is performed by the remote device and a result of the fluid leak detection is communicated by the remote device to the first edge device.

19. The method of claim 11, wherein the first edge device is connected to the first sensor through a second edge device.

20. The method of claim 11, wherein the graph model is provided to the remote device using MQTT protocol.
